(19) United States
(12) Patent Application Publication
(10) Pub. No.: US 2025/0365716 A1
(43) Pub. Date: Nov. 27, 2025

(54) GUARD-BAND DEPLOYMENT FOR WIRELESS ENERGY AND INFORMATION TRANSFER

(71) Applicant: QUALCOMM Incorporated, San Diego, CA (US)

(72) Inventors: Xiaojie WANG, Hillsborough, NJ (US); Piyush GUPTA, Bridgewater, NJ (US); Luanxia YANG, Beijing (CN); Junyi LI, Greentown, PA (US)

(21) Appl. No.: 18/874,545

(22) PCT Filed: Aug. 19, 2022
(86) PCT No.: PCT/CN2022/113486

§ 371 Date: Dec. 12, 2024

(51) Int. Cl. H04W 72/0453; H02J 50/00; H02J 50/20; H02J 50/80

(52) U.S. Cl. CPC H04W 72/0453; H02J 50/001; H02J 50/20; H02J 50/80

(57) ABSTRACT

Certain aspects of the present disclosure provide a method of wireless communication by a receiver generally including receiving, from a transmitter, configuration information indicating one or more sets of frequency resources reserved for devices capable of harvesting energy via wireless energy transfer (WET) from wireless signals, wherein the one or more sets of frequency resources are reserved within a guard-band of a radio access technology (RAT) channel bandwidth and communicating with the transmitter one or more signals using one or more sets of frequency resources based on the configuration information.

### BACKGROUND

### Field of the Disclosure

Aspects of the present disclosure relate to wireless communications, and more particularly, to techniques for guard-band deployment for wireless energy and information transfer.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a receiver. The method includes receiving, from a transmitter, configuration information indicating one or more sets of frequency resources reserved for devices capable of harvesting energy via wireless energy transfer (WET) from wireless signals, wherein the one or more sets of frequency resources are reserved within a guard-band of a radio access technology (RAT) channel bandwidth; and communicating with the transmitter one or more signals using one or more sets of frequency resources based on the configuration information.

Another aspect provides a method of wireless communication by a transmitter. The method includes transmitting, to a receiver, configuration information indicating one or more sets of frequency resources reserved for devices capable of harvesting energy via WET from wireless signals, wherein the one or more sets of frequency resources are reserved within a guard-band of a RAT channel bandwidth and communicating with the receiver one or more signals using one or more sets of frequency resources based on the configuration information.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts backscatter-based passive radio frequency identification (RFID).

FIG. 6 depicts example power density over radio frequency (RF) spectrum.

FIG. 7 depicts an example call flow diagram, in accordance with aspects of the present disclosure.

FIG. 8 depicts an example guard-band deployment for wireless energy transfer (WET) and wireless information transmission (WIT), in accordance with aspects of the present disclosure.

FIG. 9 depicts a table outlining various channel bandwidths and numerology in different frequency bands.

FIG. 10 depicts another example guard-band deployment for WET and WIT, in accordance with aspects of the present disclosure.

FIG. 11 depicts power boosting in a guard-band deployment for WET and WIT, in accordance with aspects of the present disclosure.

FIG. 12 depicts another example guard-band deployment for WET and WIT, in accordance with aspects of the present disclosure.

FIG. 13 depicts a method for wireless communications.

FIG. 14 depicts a method for wireless communications.

FIG. 15 depicts aspects of an example communications device.

FIG. 16 depicts aspects of an example communications device.

### DETAILED DESCRIPTION

Aspects of the present disclosure provide apparatuses, methods, processing systems, and computer-readable mediums for guard-band deployment for wireless energy and information transfer.

A new generation of wireless devices may overcome conventional limitations of on-board energy storage by harvesting energy from wireless signals (e.g., radio frequency (RF) signals) to perform wireless communications. Such energy harvesting devices (e.g., user equipments) may include, for example, RFID devices (e.g., RFID tags), that are capable of receiving signals and “backscattering” them to another device to perform wireless communications. These aforementioned devices may generally be passive, in which case they include no on-board energy storage and rely entirely on harvested energy from received signals to perform wireless communications (e.g., via backscattering signals). Thus, energy-harvesting devices may be considered a type of user equipment (UE) that provides low-cost and low-power solutions for many applications in a wireless communications system.

One potential limitation in deploying RFID devices is that ambient RF signal harvesting may not be feasible in certain scenarios. For example, a power level of ambient RF signals may vary based on time and location and a power density of ambient RF signals may be too low to be effective (e.g., less than 10 nW/cm²). Thus, a dedicated energy source may be required for certain applications, such as passive Internet of Things (PIoT) applications.

Aspects of the present disclosure, however, provide techniques for reserving frequency resources within a guard-band of a radio access technology (RAT) channel bandwidth for devices capable of harvesting energy via wireless energy transfer (WET). In some cases a set of frequency resources may be reserved for WET and a set of frequency resources may be reserved for wireless information transmissions (WITs) using the harvested energy. A minimum guard band may be defined between the reserved frequency resources and frequency resources associated with transmissions for the RAT to allow RF filtering to separate new radio (NR) signals and WET/WIT signals, which may comprise a small portion of NR transmission bandwidth.

By utilizing techniques presented herein, passive IoT devices may be used and powered with dedicated frequency resources in licensed spectrum at low operating expense, low power consumption, low maintenance cost, and long-life cycle.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

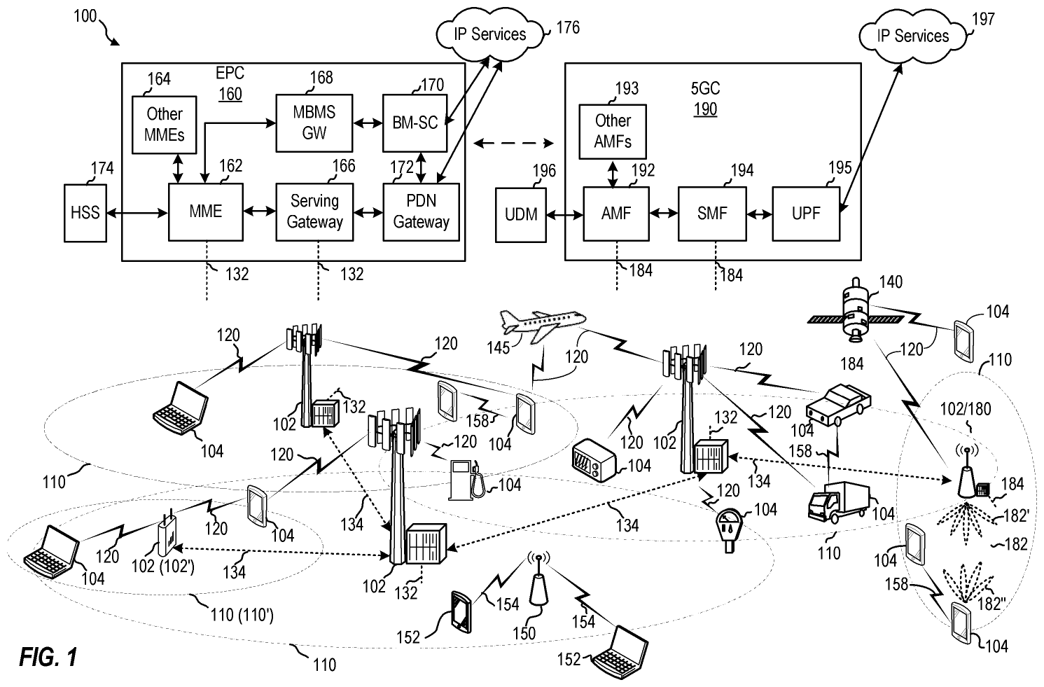

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

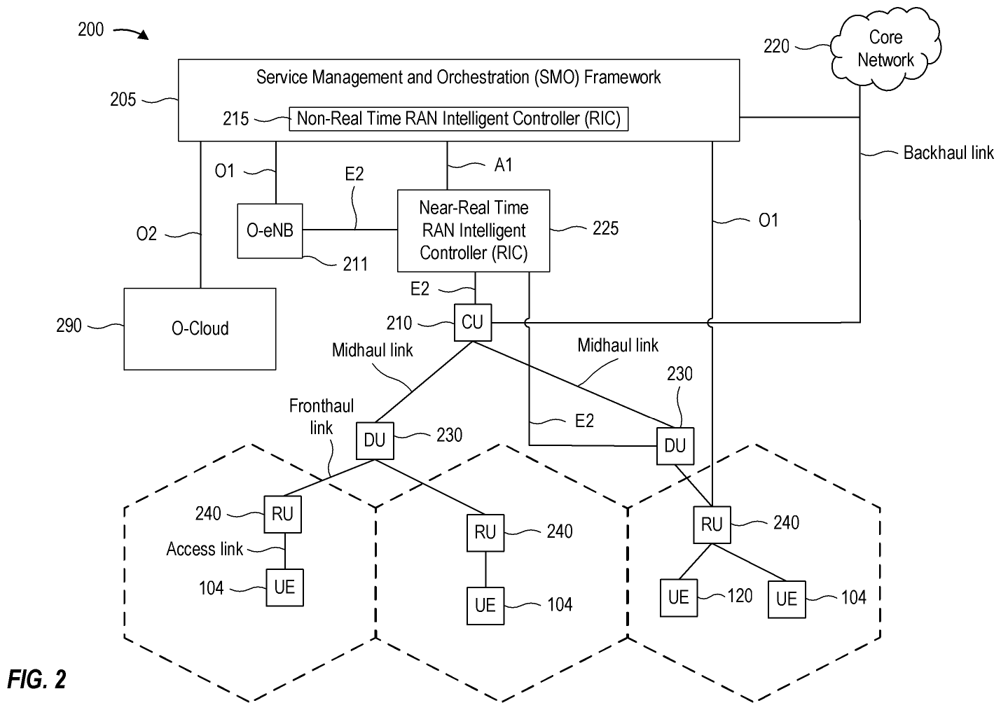

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface ), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

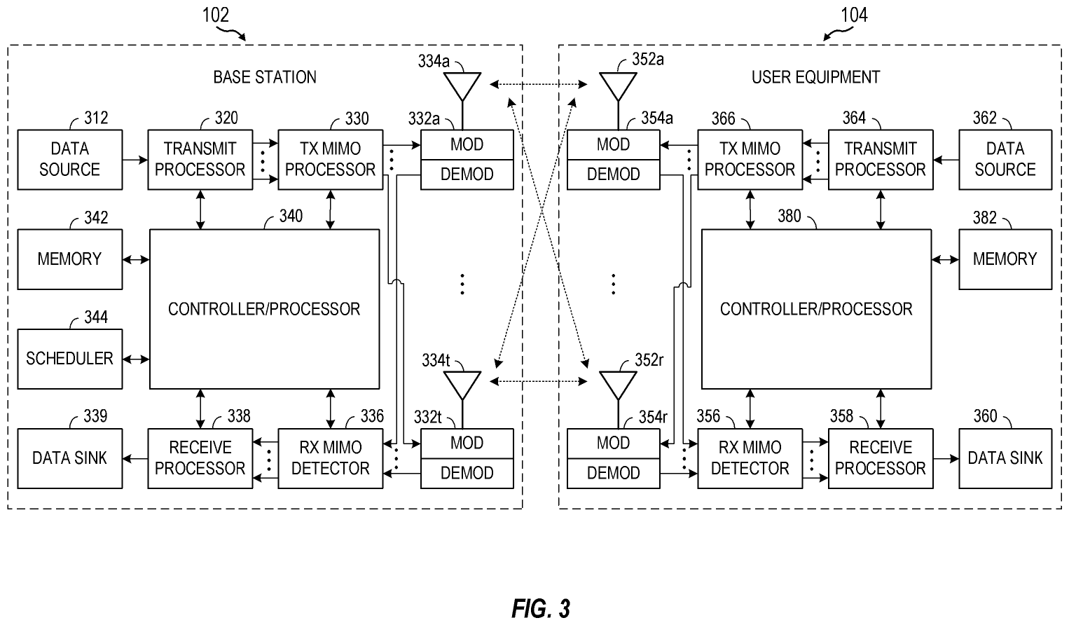

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

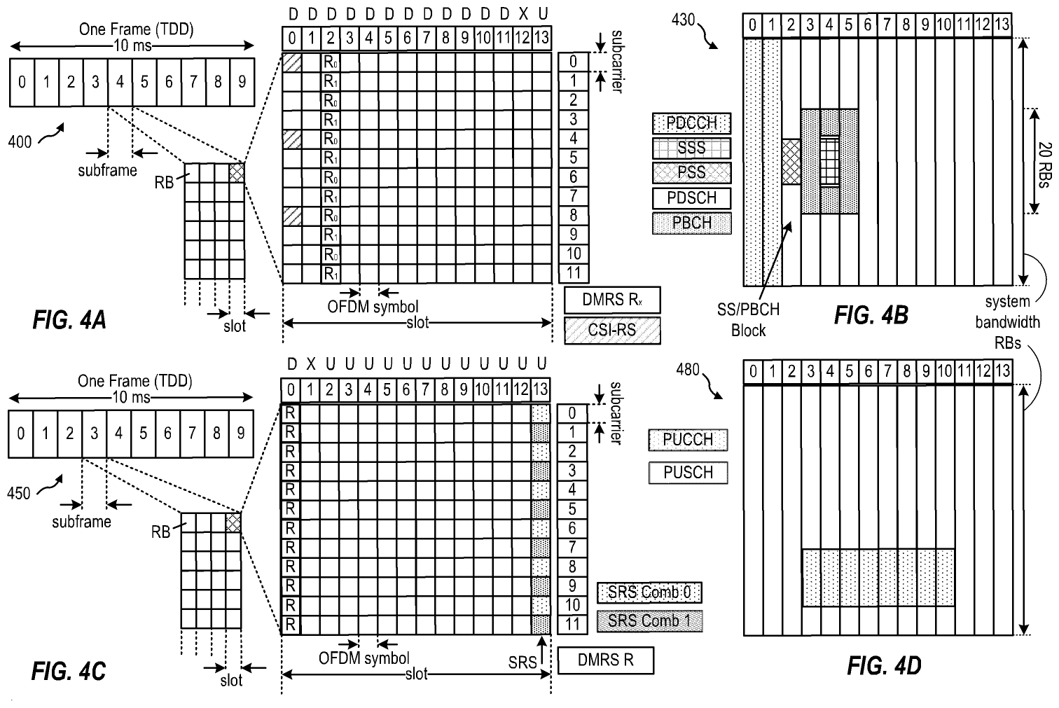

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 μ slots/subframe. The subcarrier spacing and symbol length/duration are a function of the numerology. The subcarrier spacing may be equal to 24×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

Radio frequency identification (RFID) is a rapidly growing technology impacting many industries due to its economic potential for inventory/asset management within warehouses, internet of things (IoT), sustainable sensor networks in factories and/or agriculture, and smart homes, to name a few example applications. RFID technology consists of RFID devices (or backscatter devices), such as transponders, or tags, that emit an information-bearing signal upon receiving an energizing signal.

In certain aspects, RFID devices may be operated without a battery. Generally, RFID devices that are operated without a battery are known as passive RFID devices. Passive RFID devices may operate by harvesting energy from received radio frequency signals (e.g., “over the air”), thereby powering reception and transmission circuitry within the RFID devices. This harvested energy allows passive RFID devices to transmit information, sometimes referred to as backscatter modulated information, without the need for a local power source within the RFID device. On the other hand, in certain aspects, RFID device may be semi-passive and include on-board energy storage to supplement their ability to harvest energy from received signals (however, at higher cost).

In certain aspects, in addition to harvesting power from RF sources, energy harvesting devices may accumulate energy from other direct energy sources, such as solar energy, in order to supplement its power demands. Semi-passive energy harvesting devices may, in some cases, include power consuming RF components, such as analog to digital converters (ADCs), mixers, and oscillators.

Thus, RFID devices are a type of user equipment that provides low-cost and low-power solutions for many applications in a wireless communications system. Such devices may be very power efficient, sometimes requiring less than 0.1 mW of power to operate. Further, their relatively simple architectures and, in some cases, lack of battery, mean that such devices can be small, lightweight, and easily installed or integrated in many types of environments or host devices. Generally speaking then, RFID devices provide practical and necessary solutions to many networking applications that require, low-cost, small footprint, durable, maintenance-free, and long lifespan communications devices. For example, RFID devices may be configured as long endurance industrial sensors, which mitigates the problems of replacing batteries in and around dangerous machinery.

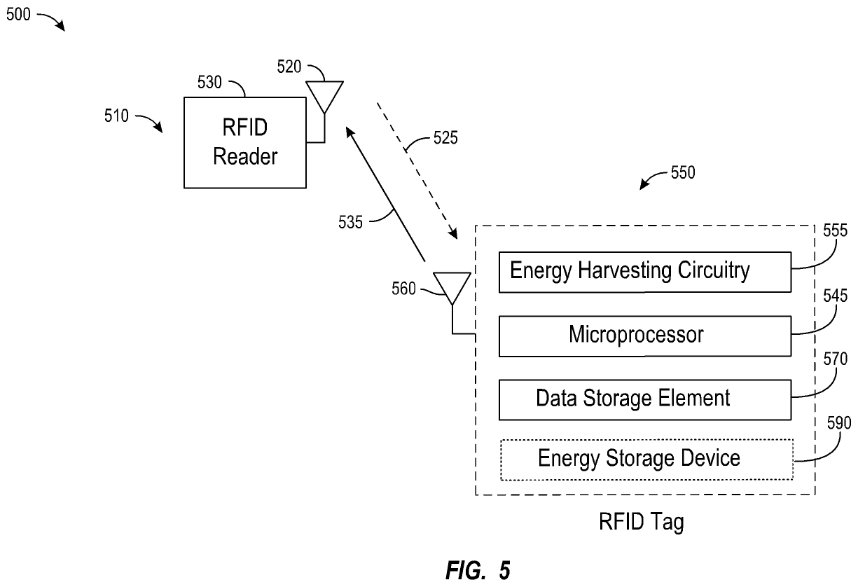

FIG. 5 shows an RFID system 500. As shown, RFID system 500 includes a reader 510 and an RFID tag 550. Reader 510 may also be referred to as an interrogator or a scanner. RFID tag 550 may also be referred to as an interrogator, RFID label, or an electronics label. In certain aspects, reader 510 is a network entity (e.g., such as a gNB) and RFID tag 550 is a user equipment (UE).

Reader 510 includes an antenna 520 and an electronics unit 530. Antenna 520 radiates signals transmitted by reader 510 and receives signals from RFID tags and/or other devices. Electronics unit 530 may include a transmitter and a receiver for reading RFID tags such as RFID tag 550. The same pair of transmitter and receiver (or another pair of transmitter and receiver) may support bi-directional communication with wireless networks, wireless devices, etc. Electronics unit 530 may include processing circuitry (e.g., a processor) to perform processing for data being transmitted and received by the RFID reader 510.

As shown, RFID tag 550 includes an antenna 560 and a data storage element 570. Antenna 560 radiates signals transmitted by RFID tag 550 and receives signals from RFID reader 510 and/or other devices. Data storage element 570 stores information for RFID tag 550, for example, in an electrically erasable programmable read-only memory (EEPROM) or another type of memory. RFID tag 550 may also include an electronics unit that can process the received signal and generate the signals to be transmitted.

In certain aspects, RFID tag 550 may be a passive RFID tag having no battery. In this case, induction may be used to power the RFID tag 550. For example, in some cases, a magnetic field from a signal transmitted by reader 510 may induce an electrical current in RFID tag 550, which may then operate based on the induced current. RFID tag 550 can radiate its signal in response to receiving a signal from RFID reader 510 or some other device. In certain other aspects, RFID tag 550 may optionally include an energy storage device 590, such as a battery, capacitor, etc., for storing energy harvested using energy harvesting circuitry 555, as described below.

In one example, RFID tag 550 may be read by placing the reader 510 within close proximity to RFID tag 550. Reader 510 may radiate a first signal 525 via the antenna 520. In some cases, the first signal 525 may be known as an interrogation signal or energy signal. In some cases, energy of the first signal 525 may be coupled from reader antenna 520 to RFID tag antenna 560 via magnetic coupling and/or other phenomena. In other words, the RFID tag 550 may receive the first signal 525 from reader 510 via antenna 560 and energy of the first signal 525 may be harvested using energy harvesting circuitry 555 (e.g., an RF transducer) and used to power RFID tag 550. For example, energy of the first signal 525 received by RFID tag 550 may be used to power a microprocessor 545 of RFID tag 550. Microprocessor 545 may, in turn, retrieve information stored in a data storage element 570 of RFID tag 550 and transmit the retrieved information via a second signal 535 using the antenna 560. For example, in some cases, microprocessor 545 may generate the second signal 535 by modulating a baseband signal (e.g., generated using energy of the first signal 525) with the information retrieved from the data storage element 570. In some cases, this second signal 535 may be known as a backscatter modulated information signal. Thereafter, as noted, microprocessor 545 transmits the second signal 535 to reader 510. Reader 510 may receive the second signal 535 from RFID tag 550 via antenna 520 and may process (e.g., demodulate) the received signal to obtain the information of data storage element 570 sent in second signal 535.

In some cases, RFID system 500 may be designed to operate at 13.56 MHz or some other frequency (e.g., an ultra-high frequency (UHF) band at 900 MHz). Reader 510 may have a specified maximum transmit power level, which may be imposed by the Federal Communication Commission (FCC) in the United Stated or other regulatory bodies in other countries. The specified maximum transmit power level of reader 510 may limit the distance at which RFID tag 550 can be read by reader 510.

Wireless technology is increasingly useful in industrial applications, such as ultra-reliable low-latency communication (URLLC) and machine type communication (MTC). In such domains, and others, it is desirable to support devices (e.g., passive RFID tags) that are capable of harvesting energy from wireless energy sources (e.g., in lieu of or in combination with a battery or other energy storage device, such as a capacitor), such as RF signals, thermal energy, solar energy, and the like.

In general, wireless devices that do not have their own power source, but rather harvest and store energy from RF transmissions from other devices, may be referred to herein as zero power (ZP) RF devices. Examples of such devices include ZP Internet of Things (ZP-IoT) devices. One example of such devices are passive internet of things (PIoT) devices, that rely on passive communication technologies, such as backscatter communication. Backscatter communication generally refers to a mechanism that allows wireless nodes, often referred to as RF tags, to communicate without active RF components. In a typical scenario, an RF tag obtains (harvests) energy from an RF transmission from a reader and is also able to modulate and reflect the signals back to the reader (hence, the term backscatter). The signal reflection typically results from designed mismatch between the antenna and the load impedance at the WTD. In some cases, the load impedance can be varied to modulate the reflected signal with information bits the reader can recover by demodulating the reflected signals.

### Aspects Related to Guard-Band Deployment for Wireless Energy Transfer and Wireless Information Transfer

One potential limitation in deploying RFID devices is that they typically support only short-range communication. For example, a reader may need to be separated by less than 10 meters from a passive Internet of Things (IoT) RFID device for an interrogating signal to be sufficiently strong for RF power harvesting (PH) circuitry on an RFID device. Such circuitry may have non-linear input power needs (e.g., due to diodes) and may need input power to be above a threshold to operate. Further, PH circuitry may have a frequency-selective conversion efficiency (e.g., being more efficient at lower frequencies due to diode junction capacitance and resistance).

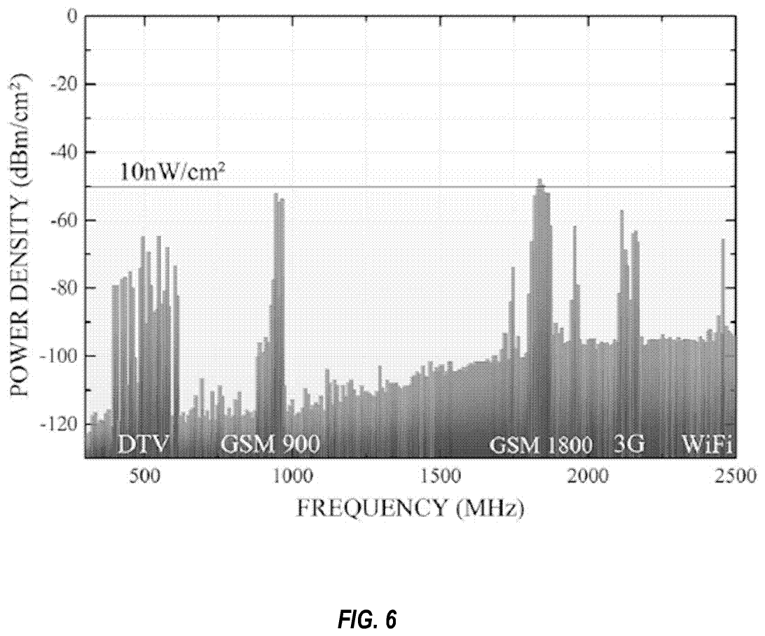

For such reasons, ambient RF signal harvesting may not be feasible in many cases. For example, as illustrated in FIG. 6, a power density of ambient RF signals (e.g., digital television (DTV), global system for mobile communications (GSM), 3G and wireless fidelity (Wifi)) may be lower than 10 nW/cm2. The actual power level may vary over time and may depend on particular locations of the zero power (ZP) RF devices.

As a result, a dedicated energy source may be considered for ZP RF devices, such as PIoT devices. According to certain aspects of the present disclosure, frequency bands may be reserved for wireless energy transfer (WET), wireless information transmission (WIT), or both. Such dedicated frequency bands may help provide energy coverage for the pervasive, perpetual wireless-powered IoT devices.

Aspects of the present disclosure, provide techniques for reserving frequency resources within a guard-band of a radio access technology (RAT) channel bandwidth for devices capable of harvesting energy via WET. In some cases a set of frequency resources may be reserved for WET, WIT, or both, using harvested energy. In some cases, a minimum guard band may be defined between the reserved frequency resources and frequency resources associated with transmissions for the RAT to allow RF filtering to separate new radio (NR) signals and WET/WIT signals, which may comprise a small portion of NR transmission bandwidth.

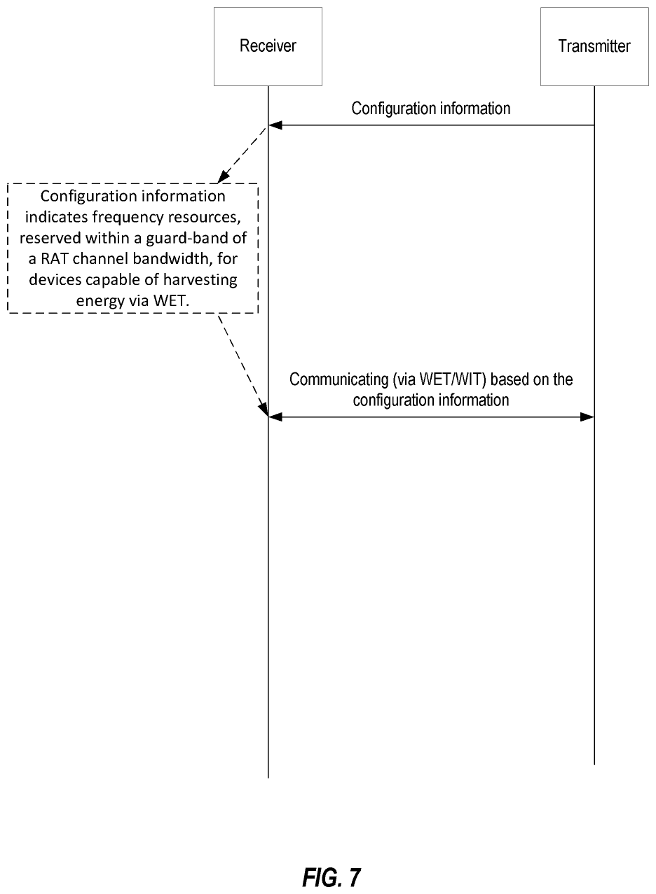

The techniques proposed herein for guard-band deployment for WET and WIT may be understood with reference to the call flow diagram 700 of FIG. 7 that shows how a receiver may be configured for communication by a transmitter. In certain aspects, the transmitter may be a network entity (e.g., a gNB) or a reader (such as RFID reader 510 illustrated in FIG. 5) and receiver may be ZP RF device, such as RFID tag 550 (where RFID tag 550 is a passive RFID device) illustrated in FIG. 5. However, in other aspects, the transmitter may be another type of wireless communications device (e.g., network entity, network node, etc.), and, similarly, the receiver may be another type of wireless communications device (e.g., UE, etc.), such as those described herein.

As illustrated in FIG. 7, the receiver (e.g., a UE) may receive configuration information from a transmitter (e.g., a network entity such as a gNB), indicating one or more sets of frequency resources reserved for devices capable of harvesting energy via WET from wireless signals. As noted above, the one or more sets of frequency resources may be reserved within a guard-band of RAT channel bandwidth. The receiver and transmitter may then communicate via one or more signals, using one or more sets of frequency resources based on the configuration information.

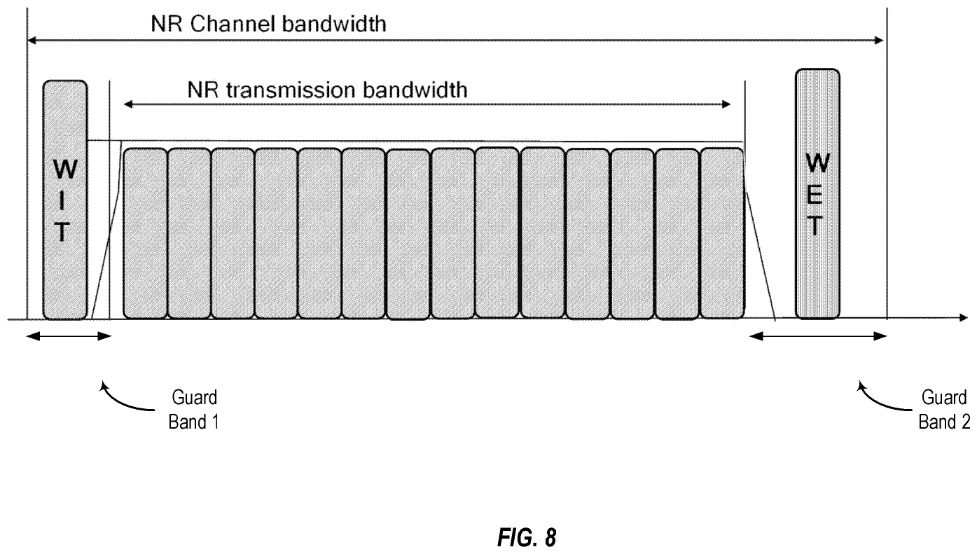

In some cases, for a guard-band deployment for WET, a network entity (e.g., a gNB) may reserve a quantity of frequency resources in the guard-band of a RAT (e.g., NR) carrier for WET, WIT, or both. Such guard-bands are typically not used for emission reduction. In the example illustrated in FIG. 8, frequency resources for WIT are located in a first guard band (Guard Band 1), while frequency resources for WET are located in a second guard band (Guard Band 2).

In some cases, the configuration information for such a guard-band deployment may be part of a cell-specific configuration and included (broadcast) as part of a master information block (MIB) or system information block (SIB). In such cases, one or multiple WET-bandwidth parts (BWPs) may be indicated in the configuration. In such cases, a UE camping on the cell may identify the WET frequencies and tune/activate its power harvesting circuit for WET on the identified band.

This approach may be a relatively straightforward deployment that could be achieved, for example, with a software update (e.g., at the gNB). The techniques described herein may allow licensed spectrum to be used for WET and/or WIT, with a more controllable interference that may allow for higher power (e.g., when compared to ultra-high frequency (UHF) RFID).

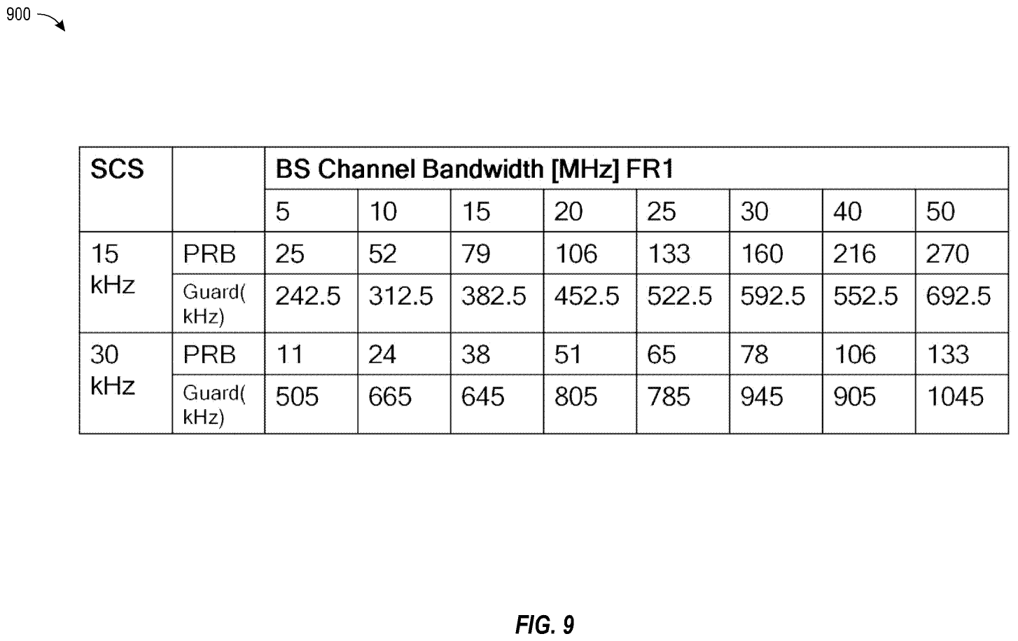

NR supports various channel bandwidths and numerologies for frequency range 1 (FR1) and frequency range 2 (FR2). In some cases, a guard band may depend on both the channel bandwidth and numerology. Table 900 of FIG. 9 illustrates examples channel bandwidths and numerology for FR1. As illustrated, guard-bands tend to be larger for larger base station (BS) channel bandwidths. As a result, guard-band deployment may be easier for NR carriers with larger BS channel bandwidth.

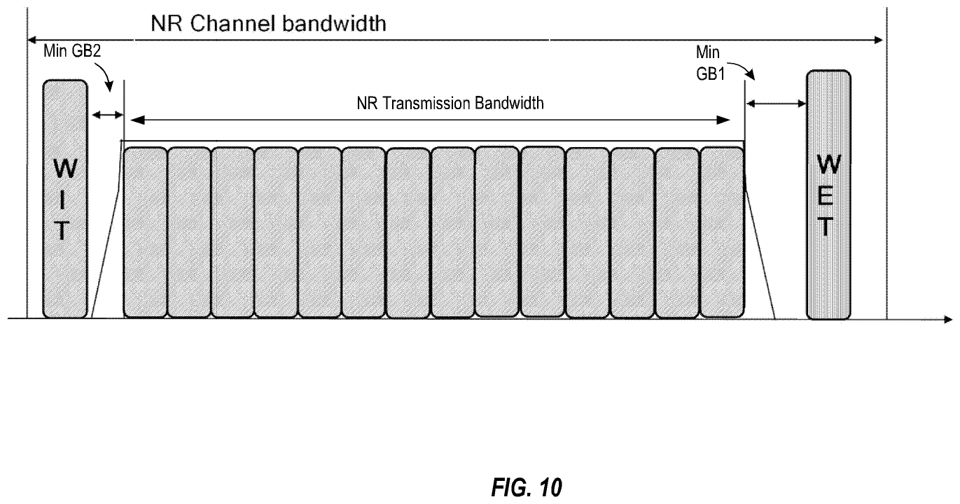

In some cases, a minimum guard band between the edges of WET and NR transmission bandwidth may be defined. For example, FIG. 10 illustrates a first minimum guard band (Min GB1) between the NR transmission bandwidth and WET frequency resources and a second minimum guard band (Min GB2) between the WIT frequency resources and NR transmission bandwidth. The minimum guard band(s) may help allow for RF filtering to separate NR signals and WET/WIT signals (e.g., a minimum may be 1% of NR transmission bandwidth).

As in the example shown in FIG. 10, in some cases, the total frequency resources for WET/WIT, the NR transmission bandwidth, and the minimum gap combined may be confined in the NR channel bandwidth. If not, the WET/WIT guard-band deployment may not be allowed.

For NR channel bandwidth larger than a threshold (e.g., 15 MHz) or for a guard band larger than a threshold (e.g., 400 kHz), emissions outside of the NR channel bandwidth may be kept as the same (e.g., within an Adjacent Channel Leakage Power Ratio (ACLR), etc.). In some cases, the limits may depend on base station (BS) class and power class (e.g., −14 dBm for wide area BS, −29 dBm for local area BS, etc.). In some cases, the limits may be defined in terms of absolute power and relative attenuation to the transmit power.

For NR channel bandwidth smaller than the threshold (e.g., 5 or 10 MHz) or for a guard band smaller than the threshold (e.g., 300 kHz), a total emission target (requirement) for WET/WIT+NR may be relaxed. For example, the increased total emission power and/or emission mask to adjacent frequencies may be relaxed.

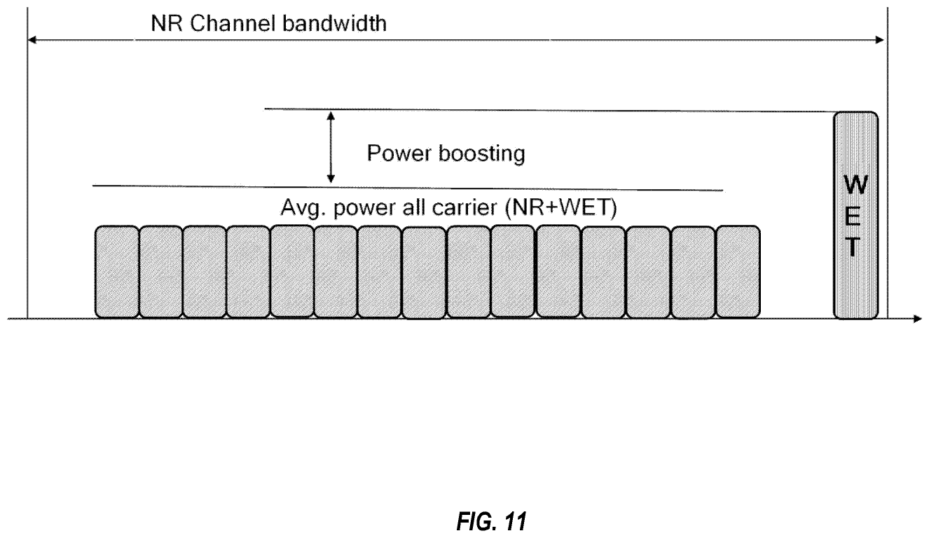

In some cases, a UE camping on a cell may also harvest energy from adjacent NR resource blocks (RBs), such as RBs used for SSBs. However, in such cases, a WET band may transmit a dedicated waveform for energy with potential power boosting. As illustrated in FIG. 11, the power boosting applied for WET may represent an increase relative to the average power over all carriers (NR+WET).

In some cases, a gNB may perform frequency division multiplexing (FDM) of WET and NR transmissions, while still satisfying a rated output power and power dynamics of each BS class declared by the manufacturer and regulation requirements. In some cases Power boosting requirements may be standardized (e.g., +3, +6 dB or 9 dB of the ratio between power on WET and the avg. power of WET+NR), in an effort to ensure coverage of energy delivery.

In some cases, power boosting may be different depending on the NR channel bandwidth and WET frequency position and the guard between NR and WET. For example, larger power boosting may be required for larger NR bandwidth and a larger guard band. On the other hand, smaller power boosting may be required if WET is at the edge of the NR channel bandwidth and, therefore, more difficult to achieve out-of-band emission (OBE) and ACLR requirements. In some cases, only one WET channel may be boosted at a time if multiple WET bands are deployed.

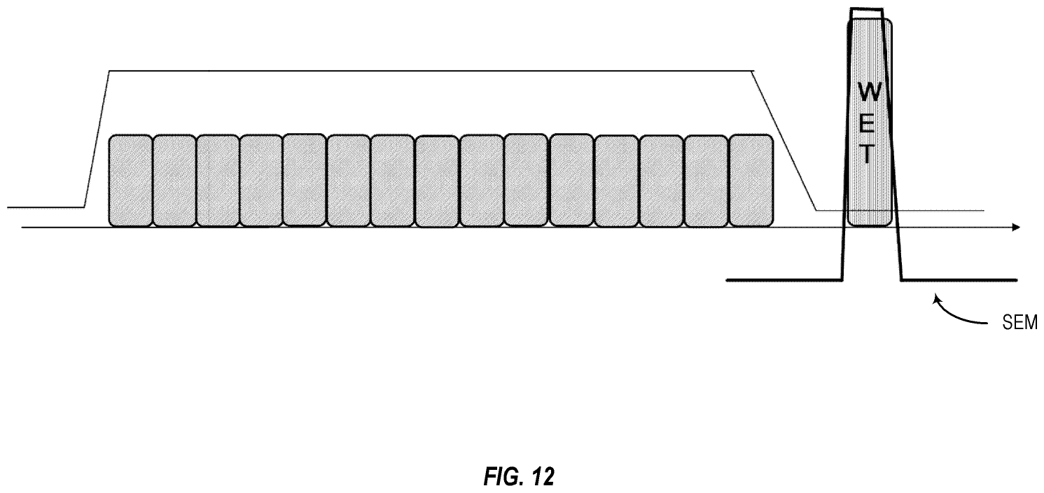

In some cases, WET frequency resources may be divided into several sub-channels. In this cases, an orthogonal frequency-division multiplexing (OFDM) waveform with subcarrier spacing (SCS) that is used by the adjacent NR-bandwidth part (BWP) may be reused. For example, a WET SCS may be the same as the adjacent NR-BWP. As illustrated in FIG. 12, in some cases, WET emission into adjacent BWPs may be defined in terms of a spectral emission mask (SEM) and total in-band emission (IBE). For example, in such cases, energy outside of the WET may be expected to not exceed a threshold and may decay for frequencies farther away from the WET.

In some cases, IBE requirements from adjacent BWPs into WET may be relaxed. For example, in such cases, NR transmission may be allowed to have higher emission to WET. In addition, in some cases, total emission for NR+WET outside of the NR carrier may be expected to still meet out-of-band (OOB) and ACLR requirements. In paired spectrum, emission requirements may be differently defined for downlink (DL) and uplink (UL) spectrum. As an alternative, or in addition, there may be supplementary DL (SDL) and/or supplementary UL (SUL). In other words, there may be different requirements for UE and gNB. In some cases, for unpaired spectrum, a gNB and UE may access the WET simultaneously.

### Example Operations of a Receiver

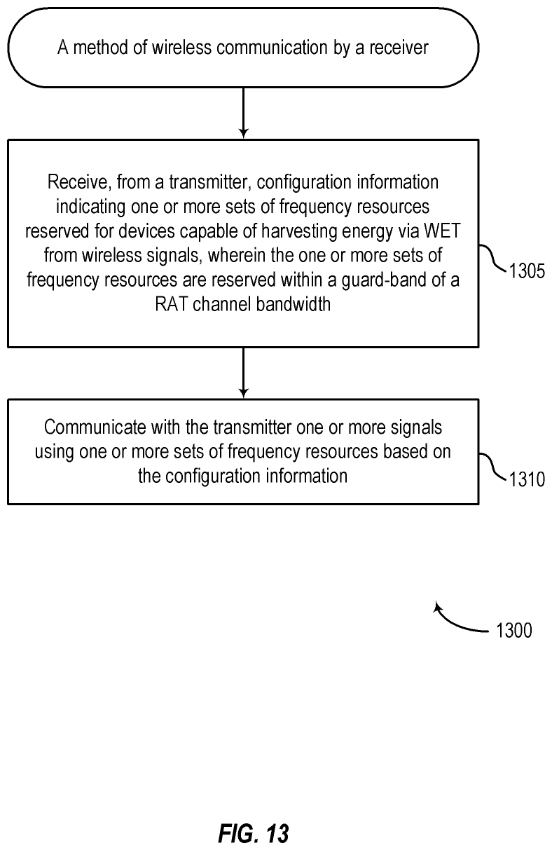

FIG. 13 shows an example of a method 1300 of wireless communication by a receiver, such as by a UE 104 of FIGS. 1 and 3.

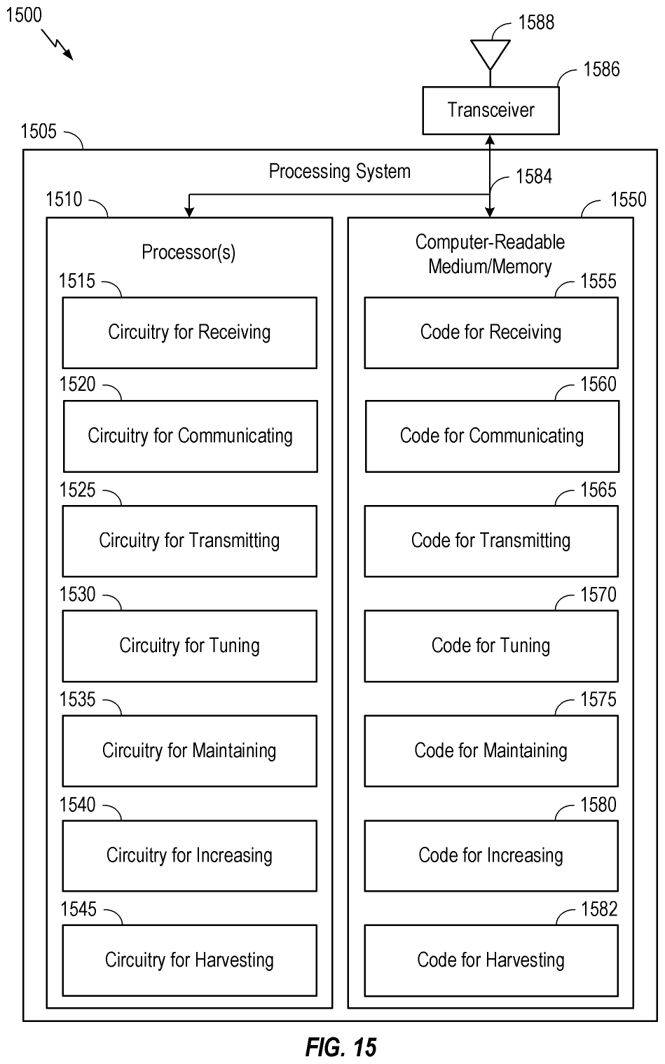

Method 1300 begins at step 1305 with receiving, from a transmitter, configuration information indicating one or more sets of frequency resources reserved for devices capable of harvesting energy via WET from wireless signals, wherein the one or more sets of frequency resources are reserved within a guard-band of a RAT channel bandwidth. In some cases, the operations of this step refer to, or may be performed by, circuitry for receiving and/or code for receiving as described with reference to FIG. 15.

Method 1300 then proceeds to step 1310 with communicating with the transmitter one or more signals using one or more sets of frequency resources based on the configuration information. In some cases, the operations of this step refer to, or may be performed by, circuitry for communicating and/or code for communicating as described with reference to FIG. 15.

In some aspects, the receiver is a UE; and the transmitter is a network entity.

In some aspects, the one or more sets of frequency resources comprise: a first set of frequency resources reserved for WET; and a second set of frequency resources reserved for WIT.

In some aspects, the method 1300 further includes at least one of: receiving an energy signal from the transmitter on the first set of frequency resources; and transmitting information to the transmitter, via WIT, in the second set of frequency resources. In some cases, the operations of this step refer to, or may be performed by, circuitry for receiving and/or code for receiving as described with reference to FIG. 15. In some cases, the operations of this step refer to, or may be performed by, circuitry for transmitting and/or code for transmitting as described with reference to FIG. 15.

In some aspects, the configuration information is cell specific; and the configuration information is received as part of a MIB or a SIB.

In some aspects, the method 1300 further includes tuning a power harvesting circuit for WET on the first set of frequency resources. In some cases, the operations of this step refer to, or may be performed by, circuitry for tuning and/or code for tuning as described with reference to FIG. 15.

In some aspects, the configuration information indicates a minimum guard band between the first set of frequency resources and frequency resources associated with transmissions for the RAT.

In some aspects, the method 1300 further includes harvesting energy from an energy signal transmitted in resource blocks adjacent to the RAT channel bandwidth. In some cases, the operations of this step refer to, or may be performed by, circuitry for harvesting and/or code for harvesting as described with reference to FIG. 15.

In some aspects, the method 1300 further includes increasing an output power associated with WET transmissions. In some cases, the operations of this step refer to, or may be performed by, circuitry for increasing and/or code for increasing as described with reference to FIG. 15.

In some aspects, the increase in output power is dependent on at least one of the RAT channel bandwidth, a WET frequency position, or the minimum guard band.

In some aspects, the method 1300 further includes maintaining a level of emissions outside of the RAT channel bandwidth when one of the RAT channel bandwidth or the guard band bandwidth exceeds a threshold value. In some cases, the operations of this step refer to, or may be performed by, circuitry for maintaining and/or code for maintaining as described with reference to FIG. 15.

In some aspects, the maintained level of emissions depends on one or more of a BS class and a power class.

In some aspects, the maintained level of emissions is defined as one of an absolute power or a relative attenuation to a transmit power.

In some aspects, the method 1300 further includes increasing a limit on total emissions outside of the RAT channel bandwidth when one of the NR channel bandwidth or the guard band bandwidth is smaller than a threshold value. In some cases, the operations of this step refer to, or may be performed by, circuitry for increasing and/or code for increasing as described with reference to FIG. 15.

In one aspect, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

### Example Operations of a Transmitter

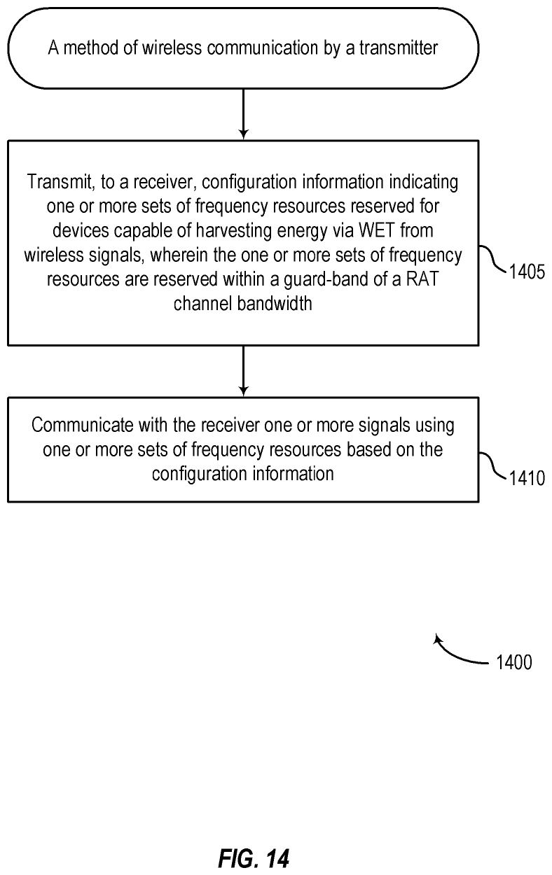

FIG. 14 shows an example of a method 1400 of wireless communication by a transmitter, such as by a BS 102 of FIGS. 1 and 3, or a disaggregated base station as discussed with respect to FIG. 2.

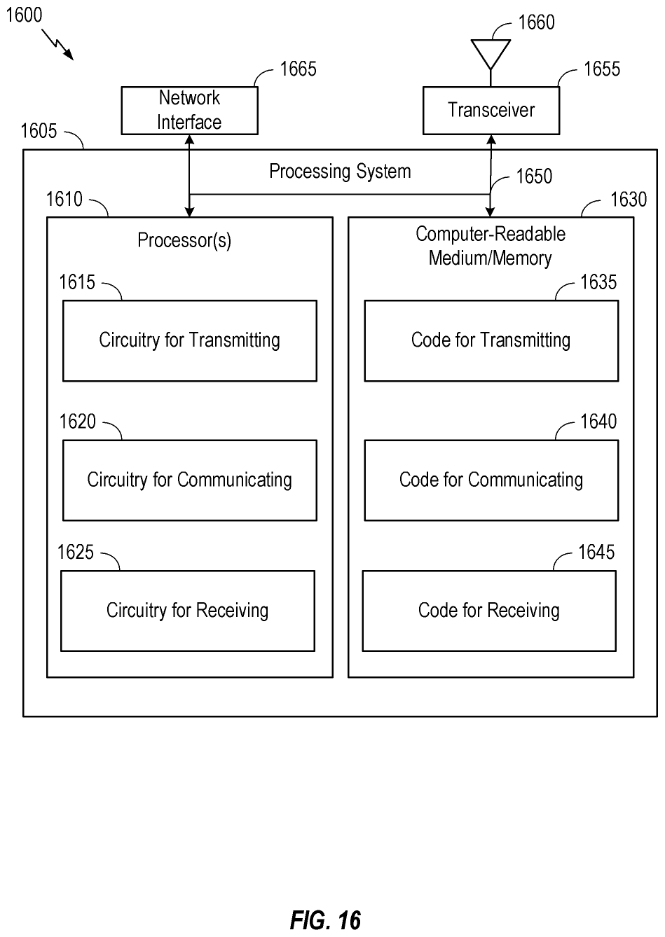

Method 1400 begins at step 1405 with transmitting, to a receiver, configuration information indicating one or more sets of frequency resources reserved for devices capable of harvesting energy via WET from wireless signals, wherein the one or more sets of frequency resources are reserved within a guard-band of a RAT channel bandwidth. In some cases, the operations of this step refer to, or may be performed by, circuitry for transmitting and/or code for transmitting as described with reference to FIG. 16.

Method 1400 then proceeds to step 1410 with communicating with the receiver one or more signals using one or more sets of frequency resources based on the configuration information. In some cases, the operations of this step refer to, or may be performed by, circuitry for communicating and/or code for communicating as described with reference to FIG. 16.

In some aspects, the receiver is a UE; and the transmitter is a network entity.

In some aspects, the one or more sets of frequency resources comprise: a first set of frequency resources reserved for WET; and a second set of frequency resources reserved for WIT.

In some aspects, the method 1400 further includes at least one of: transmitting an energy signal on the first set of frequency resources; and receiving information from the receiver, via WIT, in the second set of frequency resources. In some cases, the operations of this step refer to, or may be performed by, circuitry for transmitting and/or code for transmitting as described with reference to FIG. 16. In some cases, the operations of this step refer to, or may be performed by, circuitry for receiving and/or code for receiving as described with reference to FIG. 16.

In some aspects, the configuration information indicates a minimum guard band between the first set of frequency resources and frequency resources associated with transmissions for the RAT.

In some aspects, the configuration information is cell specific; and the configuration information is received as part of a MIB or a SIB.

In one aspect, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative steps are possible consistent with this disclosure.

### Example Communications Devices

FIG. 15 depicts aspects of an example communications device 1500. In some aspects, communications device 1500 is a user equipment, such as UE 104 described above with respect to FIGS. 1 and 3.

The communications device 1500 includes a processing system 1505 coupled to the transceiver 1586 (e.g., a transmitter and/or a receiver). The transceiver 1586 is configured to transmit and receive signals for the communications device 1500 via the antenna 1588, such as the various signals as described herein. The processing system 1505 may be configured to perform processing functions for the communications device 1500, including processing signals received and/or to be transmitted by the communications device 1500.

The processing system 1505 includes one or more processors 1510. In various aspects, the one or more processors 1510 may be representative of one or more of receive processor 358, transmit processor 364, TX MIMO processor 366, and/or controller/processor 380, as described with respect to FIG. 3. The one or more processors 1510 are coupled to a computer-readable medium/memory 1550 via a bus 1584. In certain aspects, the computer-readable medium/memory 1550 is configured to store instructions (e.g., computer-executable code) that when executed by the one or more processors 1510, cause the one or more processors 1510 to perform the method 1300 described with respect to FIG. 13, or any aspect related to it. Note that reference to a processor performing a function of communications device 1500 may include one or more processors 1510 performing that function of communications device 1500.

In the depicted example, computer-readable medium/memory 1550 stores code (e.g., executable instructions), such as code for receiving 1555, code for communicating 1560, code for transmitting 1565, code for tuning 1570, code for maintaining 1575, code for increasing 1580, and code for harvesting 1582. Processing of the code for receiving 1555, code for communicating 1560, code for transmitting 1565, code for tuning 1570, code for maintaining 1575, code for increasing 1580, and code for harvesting 1582 may cause the communications device 1500 to perform the method 1300 described with respect to FIG. 13, or any aspect related to it.

The one or more processors 1510 include circuitry configured to implement (e.g., execute) the code stored in the computer-readable medium/memory 1550, including circuitry such as circuitry for receiving 1515, circuitry for communicating 1520, circuitry for transmitting 1525, circuitry for tuning 1530, circuitry for maintaining 1535, circuitry for increasing 1540, and circuitry for harvesting 1545. Processing with circuitry for receiving 1515, circuitry for communicating 1520, circuitry for transmitting 1525, circuitry for tuning 1530, circuitry for maintaining 1535, circuitry for increasing 1540, and circuitry for harvesting 1545 may cause the communications device 1500 to perform the method 1300 described with respect to FIG. 13, or any aspect related to it.

Various components of the communications device 1500 may provide means for performing the method 1300 described with respect to FIG. 15, or any aspect related to it. For example, means for transmitting, sending or outputting for transmission may include transceivers 354 and/or antenna(s) 352 of the UE 104 illustrated in FIG. 3 and/or the transceiver 1586 and the antenna 1588 of the communications device 1500 in FIG. 15. Means for receiving or obtaining may include transceivers 354 and/or antenna(s) 352 of the UE 104 illustrated in FIG. 3 and/or the transceiver 1586 and the antenna 1588 of the communications device 1500 in FIG. 15.

FIG. 16 depicts aspects of an example communications device 1600. In some aspects, communications device 1600 is a network entity, such as BS 102 of FIGS. 1 and 3, or a disaggregated base station as discussed with respect to FIG. 2.

The communications device 1600 includes a processing system 1605 coupled to the transceiver 1655 (e.g., a transmitter and/or a receiver) and/or a network interface 1665. The transceiver 1655 is configured to transmit and receive signals for the communications device 1600 via the antenna 1660, such as the various signals as described herein. The network interface 1665 is configured to obtain and send signals for the communications device 1600 via communication link(s), such as a backhaul link, midhaul link, and/or fronthaul link as described herein, such as with respect to FIG. 2. The processing system 1605 may be configured to perform processing functions for the communications device 1600, including processing signals received and/or to be transmitted by the communications device 1600.

The processing system 1605 includes one or more processors 1610. In various aspects, one or more processors 1610 may be representative of one or more of receive processor 338, transmit processor 320, TX MIMO processor 330, and/or controller/processor 340, as described with respect to FIG. 3. The one or more processors 1610 are coupled to a computer-readable medium/memory 1630 via a bus 1650. In certain aspects, the computer-readable medium/memory 1630 is configured to store instructions (e.g., computer-executable code) that when executed by the one or more processors 1610, cause the one or more processors 1610 to perform the method 1400 described with respect to FIG. 14, or any aspect related to it. Note that reference to a processor of communications device 1600 performing a function may include one or more processors 1610 of communications device 1600 performing that function.

In the depicted example, the computer-readable medium/memory 1630 stores code (e.g., executable instructions), such as code for transmitting 1635, code for communicating 1640, and code for receiving 1645. Processing of the code for transmitting 1635, code for communicating 1640, and code for receiving 1645 may cause the communications device 1600 to perform the method 1400 described with respect to FIG. 14, or any aspect related to it.

The one or more processors 1610 include circuitry configured to implement (e.g., execute) the code stored in the computer-readable medium/memory 1630, including circuitry such as circuitry for transmitting 1615, circuitry for communicating 1620, and circuitry for receiving 1625. Processing with circuitry for transmitting 1615, circuitry for communicating 1620, and circuitry for receiving 1625 may cause the communications device 1600 to perform the method 1400 as described with respect to FIG. 14, or any aspect related to it.

Various components of the communications device 1600 may provide means for performing the method 1400 as described with respect to FIG. 14, or any aspect related to it. Means for transmitting, sending or outputting for transmission may include transceivers 332 and/or antenna(s) 334 of the BS 102 illustrated in FIG. 3 and/or the transceiver 1655 and the antenna 1660 of the communications device 1600 in FIG. 16. Means for receiving or obtaining may include transceivers 332 and/or antenna(s) 334 of the BS 102 illustrated in FIG. 3 and/or the transceiver 1655 and the antenna 1660 of the communications device 1600 in FIG. 16.

### Example Clauses

Implementation examples are described in the following numbered clauses:

Clause 1: A method of wireless communication by a receiver, comprising: receiving, from a transmitter, configuration information indicating one or more sets of frequency resources reserved for devices capable of harvesting energy via WET from wireless signals, wherein the one or more sets of frequency resources are reserved within a guard-band of a RAT channel bandwidth; and communicating with the transmitter one or more signals using one or more sets of frequency resources based on the configuration information.

Clause 2: The method of Clause 1, wherein: the receiver is a UE; and the transmitter is a network entity.

Clause 3: The method of any one of Clauses 1 and 2, wherein the one or more sets of frequency resources comprise: a first set of frequency resources reserved for WET; and a second set of frequency resources reserved for WIT.

Clause 4: The method of Clause 3, further comprising at least one of: receiving an energy signal from the transmitter on the first set of frequency resources; and transmitting information to the transmitter, via WIT, in the second set of frequency resources.

Clause 5: The method of Clause 3, wherein: the configuration information is cell specific; and the configuration information is received as part of a MIB or a SIB.

Clause 6: The method of Clause 3, further comprising: tuning a power harvesting circuit for WET on the first set of frequency resources.

Clause 7: The method of Clause 3, wherein the configuration information indicates a minimum guard band between the first set of frequency resources and frequency resources associated with transmissions for the RAT.

Clause 8: The method of Clause 3, further comprising: harvesting energy from an energy signal transmitted in resource blocks adjacent to the RAT channel bandwidth.

Clause 9: The method of Clause 8, further comprising: increasing an output power associated with WET transmissions.

Clause 10: The method of Clause 9, wherein the increase in output power is dependent on at least one of the RAT channel bandwidth, a WET frequency position, or the minimum guard band.

Clause 11: The method of any one of Clauses 1-10, further comprising: maintaining a level of emissions outside of the RAT channel bandwidth when one of the RAT channel bandwidth or the guard band bandwidth exceeds a threshold value.

Clause 12: The method of Clause 11, wherein the maintained level of emissions depends on one or more of a BS class and a power class.

Clause 13: The method of Clause 11, wherein the maintained level of emissions is defined as one of an absolute power or a relative attenuation to a transmit power.

Clause 14: The method of any one of Clauses 1-13, further comprising: increasing a limit on total emissions outside of the RAT channel bandwidth when one of the NR channel bandwidth or the guard band bandwidth is smaller than a threshold value.

Clause 15: A method of wireless communication by a transmitter, comprising: transmitting, to a receiver, configuration information indicating one or more sets of frequency resources reserved for devices capable of harvesting energy via WET from wireless signals, wherein the one or more sets of frequency resources are reserved within a guard-band of a RAT channel bandwidth; and communicating with the receiver one or more signals using one or more sets of frequency resources based on the configuration information.

Clause 16: The method of Clause 15, wherein: the receiver is a UE; and the transmitter is a network entity.

Clause 17: The method of any one of Clauses 15 and 16, wherein the one or more sets of frequency resources comprise: a first set of frequency resources reserved for WET; and a second set of frequency resources reserved for WIT.

Clause 18: The method of Clause 17, further comprising at least one of: transmitting an energy signal on the first set of frequency resources; and receiving information from the receiver, via WIT, in the second set of frequency resources.

Clause 19: The method of Clause 18, wherein: the configuration information indicates a minimum guard band between the first set of frequency resources and frequency resources associated with transmissions for the RAT.

Clause 20: The method of Clause 17, wherein the configuration information is cell specific; and the configuration information is received as part of a MIB or a SIB.

Clause 21: An apparatus, comprising: a memory comprising executable instructions; and a processor configured to execute the executable instructions and cause the apparatus to perform a method in accordance with any one of Clauses 1-20.

Clause 22: An apparatus, comprising means for performing a method in accordance with any one of Clauses 1-20.

Clause 23: A non-transitory computer-readable medium comprising executable instructions that, when executed by a processor of an apparatus, cause the apparatus to perform a method in accordance with any one of Clauses 1-20.

Clause 24: A computer program product embodied on a computer-readable storage medium comprising code for performing a method in accordance with any one of Clauses 1-20.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communication by a receiver, comprising:
receiving, from a transmitter, configuration information indicating one or more sets of frequency resources reserved for devices capable of harvesting energy via wireless energy transfer (WET) from wireless signals, wherein the one or more sets of frequency resources are reserved within a guard-band of a radio access technology (RAT) channel bandwidth; and
communicating with the transmitter one or more signals using one or more sets of frequency resources based on the configuration information.

2. The method of claim 1, wherein:
the receiver is a user equipment (UE); and
the transmitter is a network entity.

3. The method of claim 1, wherein the one or more sets of frequency resources comprise:
a first set of frequency resources reserved for wireless energy transfer (WET); and
a second set of frequency resources reserved for wireless information transmission (WIT).

4. The method of claim 3, further comprising at least one of:
receiving an energy signal from the transmitter on the first set of frequency resources; and
transmitting information to the transmitter, via WIT, in the second set of frequency resources.

5. The method of claim 3, wherein:
the configuration information is cell specific; and
the configuration information is received as part of a master information block (MIB) or a system information block (SIB).

6. The method of claim 3, further comprising tuning a power harvesting circuit for WET on the first set of frequency resources.

7. The method of claim 3, wherein the configuration information indicates a minimum guard band between the first set of frequency resources and frequency resources associated with transmissions for the RAT.

8. The method of claim 1, further comprising:
maintaining a level of emissions outside of the RAT channel bandwidth when one of the RAT channel bandwidth or the guard band bandwidth exceeds a threshold value.

9. The method of claim 8, wherein the maintained level of emissions depends on one or more of a base station (BS) class and a power class.

10. The method of claim 8, wherein the maintained level of emissions is defined as one of an absolute power or a relative attenuation to a transmit power.

11. The method of claim 1, further comprising:
increasing a limit on total emissions outside of the RAT channel bandwidth when one of the NR channel bandwidth or the guard band bandwidth is smaller than a threshold value.

12. The method of claim 3, further comprising harvesting energy from an energy signal transmitted in resource blocks adjacent to the RAT channel bandwidth.

13. The method of claim 12, further comprising increasing an output power associated with WET transmissions.

14. The method of claim 13, wherein the increase in output power is dependent on at least one of the RAT channel bandwidth, a WET frequency position, or the minimum guard band.

15. A method of wireless communication by a transmitter, comprising:
transmitting, to a receiver, configuration information indicating one or more sets of frequency resources reserved for devices capable of harvesting energy via wireless energy transfer (WET) from wireless signals, wherein the one or more sets of frequency resources are reserved within a guard-band of a radio access technology (RAT) channel bandwidth; and
communicating with the receiver one or more signals using one or more sets of frequency resources based on the configuration information.

16. The method of claim 15, wherein:
the receiver is a user equipment (UE); and
the transmitter is a network entity.

17. The method of claim 15, wherein the one or more sets of frequency resources comprise:
a first set of frequency resources reserved for wireless energy transfer (WET); and
a second set of frequency resources reserved for wireless information transmission (WIT).

18. The method of claim 17, further comprising at least one of:
transmitting an energy signal on the first set of frequency resources; and
receiving information from the receiver, via WIT, in the second set of frequency resources.

19. The method of claim 17, wherein:
the configuration information is cell specific; and
the configuration information is received as part of a master information block (MIB) or a system information block (SIB).

20. The method of claim 18, wherein the configuration information indicates a minimum guard band between the first set of frequency resources and frequency resources associated with transmissions for the RAT.

21. An apparatus for wireless communication at a receiver, comprising:
a memory comprising computer-executable instructions; and
a processor configured to execute the computer-executable instructions and cause the apparatus to:
receive, from a transmitter, configuration information indicating one or more sets of frequency resources reserved for devices capable of harvesting energy via wireless energy transfer (WET) from wireless signals, wherein the one or more sets of frequency resources are reserved within a guard-band of a radio access technology (RAT) channel bandwidth; and
communicate with the transmitter one or more signals using one or more sets of frequency resources based on the configuration information.

22. The apparatus of claim 21, wherein:
the receiver is a user equipment (UE); and
the transmitter is a network entity.

23. The apparatus of claim 21, wherein the one or more sets of frequency resources comprise:
a first set of frequency resources reserved for wireless energy transfer (WET); and
a second set of frequency resources reserved for wireless information transmission (WIT).

24. The apparatus of claim 23, wherein the processor configured to execute the computer-executable instructions and further cause the apparatus to at least one of:
receive an energy signal from the transmitter on the first set of frequency resources; and
transmit information to the transmitter, via WIT, in the second set of frequency resources.

25. The apparatus of claim 23, wherein:
the configuration information is cell specific; and
the configuration information is received as part of a master information block (MIB) or a system information block (SIB).

26. The apparatus of claim 23, wherein the processor configured to execute the computer-executable instructions and further cause the apparatus to tune a power harvesting circuit for WET on the first set of frequency resources.

27. The apparatus of claim 23, wherein the configuration information indicates a minimum guard band between the first set of frequency resources and frequency resources associated with transmissions for the RAT.

28. The apparatus of claim 21, wherein the processor configured to execute the computer-executable instructions and further cause the apparatus to:
maintain a level of emissions outside of the RAT channel bandwidth when one of the RAT channel bandwidth or the guard band bandwidth exceeds a threshold value.

29. The apparatus of claim 28, wherein the maintained level of emissions depends on one or more of a base station (BS) class and a power class.

30. An apparatus for wireless communication at a transmitter, comprising:
a memory comprising computer-executable instructions; and
a processor configured to execute the computer-executable instructions and cause the apparatus to:
transmit, to a receiver, configuration information indicating one or more sets of frequency resources reserved for devices capable of harvesting energy via wireless energy transfer (WET) from wireless signals, wherein the one or more sets of frequency resources are reserved within a guard-band of a radio access technology (RAT) channel bandwidth; and
communicate with the receiver one or more signals using one or more sets of frequency resources based on the configuration information.
